(19) United States
(12) Patent Application Publication
(10) Pub. No.: US 2026/0079852 A1
(43) Pub. Date: Mar. 19, 2026

(54) CONTROLLING ACCESS TO MEMORY LOCATIONS

(71) Applicants: Apple Inc., Cupertino, CA (US); Arm Limited, Cambridge (GB)

(72) Inventors: Alexander Donald Charles CHADWICK, Cambridge (GB); Jeff GONION, Campbell, CA (US); Bernard J. SEMERIA, Palo Alto, CA (US)

(21) Appl. No.: 19/325,280

(22) Filed: Sep. 10, 2025

Related U.S. Application Data
(60) Provisional application No. 63/695,973, filed on Sep. 18, 2024.

(51) Int. Cl. G06F 12/14; G06F 9/38; G06F 21/62

(52) U.S. Cl. CPC G06F 12/1458; G06F 9/3802; G06F 21/6218; G06F 2212/1052

(57) ABSTRACT

Apparatuses, methods, computer programs, and computer-readable storage media are disclosed, wherein an instruction associated with instruction fetch address is fetched and processing performs, when the instruction comprises a request specifying a target memory address, an operation dependent on the target memory address. Registers hold values indicative of a current processing state and a current execution context identifier register holds a current execution context identifier indicative of a current execution context within a current process that caused the instruction to be fetched. Memory security, when the instruction comprises the request specifying the target memory address, determines, based on the instruction fetch address, a current region identifier; determines, based on the current region identifier and the current execution context identifier, a permissions index. A target region identifier is determined based on the target memory address and a lookup in a permissions table, based on the permissions index and the target region identifier, yields permissions information for requests issued in response to instructions associated with the current execution context identifier and the current region identifier that specify the target memory address. Based on the permissions information it is determined whether the request is prohibited.

This application claims the benefit of priority to U.S. Provisional App. Ser. No. 63/695,973, titled “CONTROLLING ACCESS TO MEMORY LOCATIONS,” filed on September 18, 2024, which is incorporated herein by reference in its entirety.

### TECHNICAL FIELD

The present disclosure relates to data processing. In particular, the present disclosure relates to controlling access to memory locations.

### DESCRIPTION

A data processing apparatus that executes data processing instructions will typically frequently access various memory locations in order to perform the data processing operations specified by those data processing instructions. Where the data processing apparatus will often also support multiple concurrent processes, it is consequently required to provide mechanisms to ensure that different processes only have access to defined sets of memory locations, such that for example certain memory locations may only be accessed by a particular process and not by any others.

### SUMMARY

In one example embodiment described herein there is an apparatus comprising:

instruction fetch circuitry responsive to an instruction fetch address to fetch an instruction associated with the instruction fetch address;

processing circuitry responsive to the instruction to perform, when the instruction comprises a request specifying a target memory address, an operation dependent on the target memory address;

register circuitry to hold values indicative of a current processing state of the processing circuitry, wherein the register circuitry comprises a current execution context identifier register to hold a current execution context identifier indicative of a current execution context within a current process which has caused the instruction to be fetched; and

memory security circuitry to, when the instruction comprises the request specifying the target memory address:

determine, based on the instruction fetch address, a current region identifier;

determine, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

In one example embodiment described herein there is a method comprising:

fetching, in response to an instruction fetch address, an instruction associated with the instruction fetch address;

holding values in registers indicative of a current processing state, wherein the registers comprises a current execution context identifier register to hold a current execution context identifier indicative of a current execution context within a current process which has caused the instruction to be fetched;

when the instruction comprises a request specifying a target memory address:

performing, in response to the instruction, an operation dependent on the target memory address; and

when the instruction comprises the request specifying the target memory address:

determining, based on the instruction fetch address, a current region identifier;

determining, based on the current region identifier and the current execution context identifier, a permissions index;

determining, based on the target memory address, a target region identifier;

performing a lookup in a permissions table, based on the permissions index and the target region identifier, to yield permissions information for requests issued in response to instructions associated with the current execution context identifier and the current region identifier that specify the target memory address;

determining, based on the permissions information, whether the request is prohibited; and

issuing, in response to determining that the request is prohibited, a response to the processing circuitry indicating that the request is prohibited.

In one example embodiment described herein there is a computer program for controlling a host data processing apparatus to provide an instruction execution environment, the computer program comprising:

instruction fetch program logic responsive to an instruction fetch address to fetch an instruction associated with the instruction fetch address;

processing program logic responsive to the instruction to perform, when the instruction comprises a request specifying a target memory address, an operation dependent on the target memory address;

register program logic to hold values indicative of a current processing state of the processing program logic, wherein the register program logic comprises a current execution context identifier register program logic to hold a current execution context identifier indicative of a current execution context within a current process which has caused the instruction to be fetched; and

memory security program logic to, when the instruction comprises the request specifying the target memory address:

determine, based on the instruction fetch address, a current region identifier;

determine, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus embodying the present techniques in accordance with some examples;

FIG. 2 schematically illustrates a data processing apparatus embodying the present techniques in accordance with some examples;

FIGS. 3A and 3B schematically illustrate the imposition of access restrictions in accordance with some examples;

FIGS. 4A and 4B schematically illustrate the imposition of access restrictions in accordance with some examples;

FIGS. 5A and 5B schematically illustrate the imposition of access restrictions for calls into a shared library in accordance with some examples;

FIGS. 6A and 6B schematically illustrate the use of a permissions overlay table to control access restrictions dependent on the code seeking access and the target to which access is sought in accordance with some examples;

FIG. 7 schematically illustrates a two-stage permissions look-up process in accordance with some examples;

FIGS. 8A and 8B schematically illustrate the use of an instruction region table and a permission overlay table to support a two-stage permissions look-up process in accordance with some examples;

FIG. 9 schematically illustrates an example permission computation for a load instruction in accordance with some examples;

FIG. 10 schematically illustrates part of an apparatus comprising a memory management unit that control access permissions in accordance with some examples; FIG. 11 schematically illustrates an example permission computation for a branch instruction in accordance with some examples;

FIG. 12 schematically illustrates an example permission computation for code execution that crosses a page boundary in accordance with some examples;

FIG. 13 is a flow diagram showing a sequence of steps which are taken in accordance with the method of some examples; and

FIG. 14 schematically illustrates a simulator implementation that may be used.

### DESCRIPTION OF EXAMPLE EMBODIMENTS

Before discussing the embodiments with reference to the accompanying figures, the following description of embodiments is provided.

In accordance with one example configuration there is provided an apparatus comprising:

instruction fetch circuitry responsive to an instruction fetch address to fetch an instruction associated with the instruction fetch address;

processing circuitry responsive to the instruction to perform, when the instruction comprises a request specifying a target memory address, an operation dependent on the target memory address;

register circuitry to hold values indicative of a current processing state of the processing circuitry, wherein the register circuitry comprises a current execution context identifier register to hold a current execution context identifier indicative of a current execution context within a current process which has caused the instruction to be fetched; and

memory security circuitry to, when the instruction comprises the request specifying the target memory address:

determine, based on the instruction fetch address, a current region identifier;

determine, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

Amongst the sequence of instructions that the processing circuitry executes, an instruction comprising a request specifying a target memory address may be encountered and a first level of protection for this target memory address can be provided by permission information associated with the target memory address. Such permission information is commonly accessed as part of a page table entry, so that it can be checked as part of an address translation process converting virtual to physical memory addresses. This approach further means that different processes executing on the processing circuitry can each be given their own view of memory and where more than one process has access to the same physical memory address, each process can be allocated different permissions with respect to that address. For example, whilst a first process may have read-write access to the address, a second process may be restricted only to have read access to that address. The present techniques recognise further however that there may be circumstances in which a finer level of granularity to the access permissions control would be beneficial. That is, that access control is not only determined on a process-by-process basis, but also that access control is differentiated within a given process between different parts of that process. In particular, differentiation can be made for the particular code (sequence of instructions) that the process is currently executing. Accordingly, depending on the nature and role of a given portion of code that may be executed within a given process, different access permissions can be allocated.

For this purpose, the register circuitry comprises a current execution context identifier register that holds a current execution context identifier that is indicative of a current execution context within a current process that has caused the instruction to be fetched. Note that the use of “indicative of a current execution context” here means that the current execution context identifier does not necessarily precisely define the current context, but rather could be an element of the current context and thus provide information about the current context. The instruction fetch address is used to determine a current region identifier and this information, together with the current execution context identifier is used to determine a permissions index. For example, a lookup may be performed in an instruction region table to yield a permissions index. Accordingly, it will be understood that this permissions index depends not only on the currently executing process but further on the specific section of code that that process is executing. Then, the permissions index is used to select a set of entries in a permissions table and a target region identifier based on the target memory address is used to select from amongst those entries to yield permissions information. Accordingly the permissions information so determined (and thus the access control supported) is dependent not only on the target memory address to which access is sought, but also on the particular code sequence being executed by the current process which is seeking access to that target memory address.

The permissions index may be determined in a variety of ways, but in some examples an instruction region table may be stored in a variety of locations that are accessible to the memory security circuitry. In some examples the memory security circuitry comprises table access circuitry to perform a look-up in the instruction region table in memory based on the current region identifier and the current execution context identifier to determine the permissions index.

The instruction region table may be variously structured, but in some examples the instruction region table is a one-dimensional table and the memory security circuitry is configured to concatenate the current region identifier and the current execution context identifier to provide an index for the look-up in the instruction region table.

Similarly the permissions table may be stored in a variety of locations that are accessible to the memory security circuitry, but in some examples the memory security circuitry comprises table access circuitry to perform a look-up in the permissions table in memory based on the permissions index and the target region identifier to determine the permissions information.

The permissions table may be variously structured, but in some examples the permissions table is a two-dimensional table and the memory security circuitry is configured to use the permissions index as a first index and the target region identifier as a second index for the look-up in the permissions table.

A first level of memory access control, which determined whether a request is allowed or prohibited based on the target memory address, may be provided in a variety of ways, but in some examples the memory security circuitry is configured to: determine, based on page table access permissions information derived from a page table entry associated with the target memory address, whether the request is prohibited; and issue, in response to determining that request is prohibited based on at least one of the permissions information and the page table access permissions information, the response indicating that the request is prohibited.

In such examples in which a page table entry associated with the target memory address is accessed, the page table entry may provide other additional information such as a region identifier, which in the case of a page table entry associated with the instruction fetch address can provide the current region identifier, whilst in the case of a page table entry associated with the target memory address can provide the target region identifier. Accordingly, in some examples the memory security circuitry is configured to determine the current region identifier by accessing a page table entry associated with the instruction fetch address and to determine the target region identifier by accessing a page table entry associated with the target memory address, wherein page table entries comprise the page table access permissions information and a region identifier, wherein the region identifier is the current region identifier in the page table entry associated with the instruction fetch address and the region identifier is the target region identifier in the page table entry associated with the target memory address.

The page table entries may be provided in support of an address translation mechanism (for example allowing virtual memory addresses used by a process executing on the processing circuitry to be converted into physical memory addresses used in the memory system). Such an address translation mechanism may be arranged to store local copies of recently-used address translations to take advantage of temporal locality in the address translations required and avoid a full translation process each time such address translations are required. Region identifiers associated with the memory addresses that are translated may in some examples also be stored (e.g. cached) with the recently-used address translation information. Hence in some examples, the memory security circuitry is configured to perform address translations with reference to address translation information derived from page table entries in memory, wherein the memory security circuitry comprises address translation storage to store local copies of recently-used address translation information, and wherein the memory security circuitry is configured to store associated region identifiers with the local copies of recently-used address translation information in the address translation storage.

Further, associated permissions information may also be stored, either in further storage distinct from the address translation storage or in a combined entry within the address translation storage. Hence in some examples, the memory security circuitry is configured to store local copies of recently-used target region identifiers in the address translation storage, and wherein the memory security circuitry is responsive to a cache hit on a local copy of a recently-used target region identifier to retrieve corresponding permissions information from a further storage. Equally in some examples, the memory security circuitry is configured generate a combined entry in dependence on the target region identifier and the permissions information for storage in the address translation storage.

The page table access permissions information and the permissions information may be combined in various ways. For example a permissive approach could be taken in which an access to a given memory location is permitted if either the page table access permissions information or the permissions information (from the permissions tables) indicate the access to be allowed. Alternatively a restrictive approach could be taken in which an access to a given memory location is prohibited if either the page table access permissions information or the permissions information (from the permissions tables) indicate the access to be forbidden. Thus in some examples, generally, the memory security circuitry is configured to modify the page table access permissions information by the permissions information when determining whether the request is prohibited. In examples where the restrictive approach is taken, the memory security circuitry is configured to remove permissions from the page table access permissions information based on the permissions information when determining whether the request is prohibited.

The instruction region table and the permissions table may be stored in and accessed in memory, and in such examples the permissions index is retrieved from an instruction region table in memory based on the current region identifier and the current execution context identifier and wherein the permissions information is retrieved from a permissions table in memory based on the permissions index and the target region identifier.

Additional control may be provided in such examples, by providing multiple instruction region tables and permissions tables for use in different circumstances, such as corresponding to different exception levels (privilege levels), and accordingly in some examples the register circuitry comprises at least one table base address register to store base addresses for the instruction region table and the permissions table. Control over the content of the table base address register(s) thus controls which instruction region table and permissions table is used.

As mentioned, different instruction region tables and permissions tables may be used depending on the current privilege level and so in some examples, the processing circuitry is configured to operate in a current mode of a less privileged mode and a more privileged mode, wherein when in the less privileged mode the permissions index is retrieved from an first instruction region table and when in the more privileged mode the permissions index is retrieved from a second instruction region table, and wherein when in the less privileged mode the permissions information is retrieved from a first permissions table and when in the more privileged mode the permissions information is retrieved from a second permissions table.

In some examples the current region identifier is the same as the target region identifier.

In accordance with one example configuration there is provided a method comprising:

fetching, in response to an instruction fetch address, an instruction associated with the instruction fetch address;

holding values in registers indicative of a current processing state, wherein the registers comprises a current execution context identifier register to hold a current execution context identifier indicative of a current execution context within a current process which has caused the instruction to be fetched;

when the instruction comprises a request specifying a target memory address:

performing, in response to the instruction, an operation dependent on the target memory address; and

when the instruction comprises the request specifying the target memory address:

determining, based on the instruction fetch address, a current region identifier;

determining, based on the current region identifier and the current execution context identifier, a permissions index;

determining, based on the target memory address, a target region identifier;

performing a lookup in a permissions table, based on the permissions index and the target region identifier, to yield permissions information for requests issued in response to instructions associated with the current execution context identifier and the current region identifier that specify the target memory address;

determining, based on the permissions information, whether the request is prohibited; and

issuing, in response to determining that the request is prohibited, a response to the processing circuitry indicating that the request is prohibited.

In accordance with one example configuration there is provided a computer program for controlling a host data processing apparatus to provide an instruction execution environment, the computer program comprising:

instruction fetch program logic responsive to an instruction fetch address to fetch an instruction associated with the instruction fetch address;

processing program logic responsive to the instruction to perform, when the instruction comprises a request specifying a target memory address, an operation dependent on the target memory address;

register program logic to hold values indicative of a current processing state of the processing program logic, wherein the register program logic comprises a current execution context identifier register program logic to hold a current execution context identifier indicative of a current execution context within a current process which has caused the instruction to be fetched; and

memory security program logic to, when the instruction comprises the request specifying the target memory address:

determine, based on the instruction fetch address, a current region identifier;

determining, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

In accordance with one example configuration there is provided a computer-readable storage medium to store the above recited computer program.

Particular embodiments will now be described with reference to the figures.

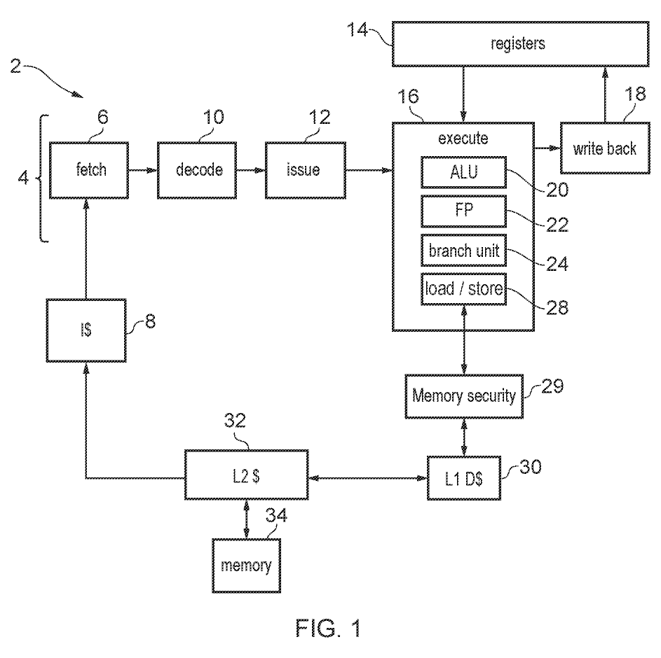

FIG. 1 illustrates a data processing apparatus 2 in accordance with one example embodiment. The apparatus 2 has a processing pipeline 4 that includes a number of pipeline stages. In this example, the pipeline stages include: a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. In the example shown, the execution units include an arithmetic/logic unit (ALU) 20 for performing arithmetic or logical operations; a floating-point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34. In this example, the memory system includes a level one data cache (L1D$) 30, a level one instruction cache (L1I$) 8, a shared level two cache (L2$) 32, and main system memory 34. It will be appreciated that this is just one example of a possible memory hierarchy and other arrangements of caches can be provided. Further shown is a memory security unit 29 that is configured to determine, for memory access requests received from the execute unit 16, whether the requested access to a target memory address of a memory access request is permitted. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or other memory management mechanisms.

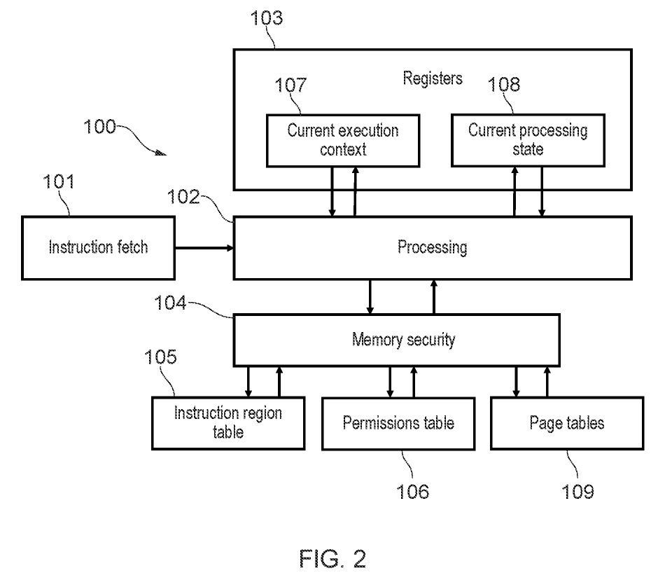

FIG. 2 schematically illustrates in more detail some key components of an apparatus 100 in accordance with the present techniques. The apparatus 100 comprises instruction fetch circuitry 101 that is configured to fetch a sequence of instructions from the memory system for execution by the processing circuitry 102. In a manner with which the person of ordinary skill in the art will be familiar, the sequence of instructions fetched may be dictated by a program counter value corresponding to memory addresses at which those instructions are stored, whereby the program counter value is generally incremented to indicate the next instruction to be fetched and executed, except when it is caused to jump to a different section of program code, for example when a branch is encountered. Some of the instructions executed by the processing circuitry comprise a request specifying a target memory address and the processing circuitry may perform an operation dependent on the target memory address. Whether the processing circuitry is permitted to access the target memory address and thus to perform the operation is controlled by the memory security circuitry 104. Data processing performed by the processing circuitry 102 comprises accessing data values temporarily stored in the registers 103. The registers 103 hold data values with a variety of purposes, for example whilst some register data values, such those in the current processing state register file 108, hold values indicative of a current processing state of the processing circuitry and dictate the current operational configuration of the apparatus, other register data values are obtained by retrieval from the memory system as the subject of the data processing operations that the processing circuitry carries out. When modified by the data processing operations these data values may then be written back to the memory system. The figure further shows the current execution context identifier register 107 that holds a current execution context identifier indicative of a current execution context within a current process that has caused the current instruction to be fetched. The memory security circuitry 104 is further configured to determine, for given memory access request, whether that memory access request is permitted to proceed or not, based both on the target memory address and on the originating particular process and program code, the execution of which has resulted in this memory access request. To do this the memory security circuitry 104 firstly determines with reference to page tables 109, based on the instruction fetch address, a current region identifier. It then determines a permissions index based on the current region identifier and the current execution context identifier provided by the current execution context identifier register 107. This may be by performing a lookup in an instruction region table 105, where this lookup yields the permissions index. The memory security circuitry 104 also determines, based on the target memory address, a target region identifier. It then performs a lookup in a permissions table 106, based on the permissions index and the target region identifier, to yield permissions information for requests issued in response to instructions associated with the current execution context identifier and the current region identifier that specify the target memory address. The permissions information dictate whether the subject request is allowed or prohibited, and consequently the memory security circuitry can then either allow the request to proceed or signal a response to the processing circuitry indicating that the request is prohibited.

The configuration of the memory security circuitry, in particular the memory access control that it provides, based not only on the target memory address to which access is sought, but also on the particular code sequence being executed by the current process that is seeking access to that target memory address, may be beneficial in a number of scenarios. The present techniques recognise that a single application may comprise program code from many disparate origins, such as (common) language runtime, standard libraries, memory allocation functions (malloc), a dynamic linker / loader, shared libraries, application logic and user interface (UI) code. Moreover, amongst runtime-compiled / JIT (just-in-time) code there may be the input code, the JIT compiler, the JIT validator, and the JIT output region. In another example, kernel code may comprise memory management (mm) code, rest-of-kernel code, and kernel-mode drivers. It may be desirable to sandbox these disparate code components from one another, even doing so in both directions. Some examples of the protections that may be desired are that: only malloc code can read / write malloc metadata; only malloc code can write memory tagging extension (MTE) tags; only JIT validator code can write to a JIT output region; WebAssembly (WASM) code regions can only read / write their own heap; shared libraries can only read / write heap (sub)regions of the component that called them; a JIT execution region cannot call an SVC (supervisor call) or sign new pointers using pointer authentication code (PAC). Such sandboxing of defined code components from one another is provided by the present techniques, some use case examples of which are discussed with reference to the next figures.

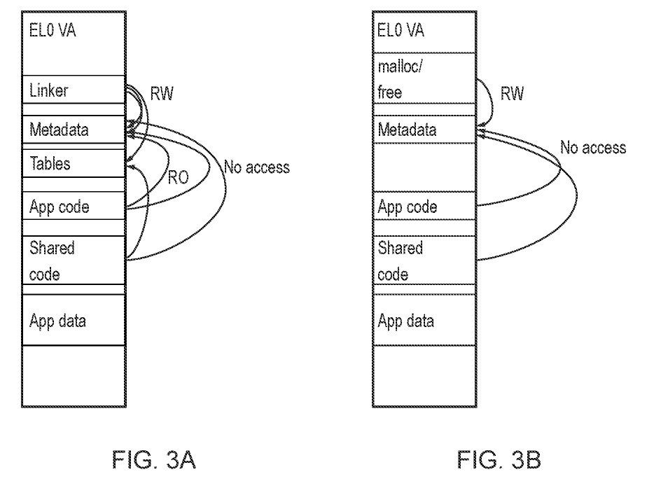

FIG. 3A illustrates an example of further access restrictions being imposed within a given process. In the example shown, code being executed at EL0 (“exception level 0” – the lowest level of privilege in the system) operates within the virtual address (VA) memory space allocated to an application. A dynamic linker is used and the code of that dynamic linker is given read / write access to a region of the VA space for the creation of some tables and associated metadata. The application code is given only read access to those tables and metadata, whilst shared code in this VA space is not permitted to access those tables and metadata at all. FIG. 3B illustrates another example of further access restrictions being imposed within a given process. Here too an application is executing at EL0 within the same VA memory space. Malloc is used and has read / write access to a region of the VA space where metadata is stored. The application code and shared code in this VA space are not permitted to access the metadata at all.

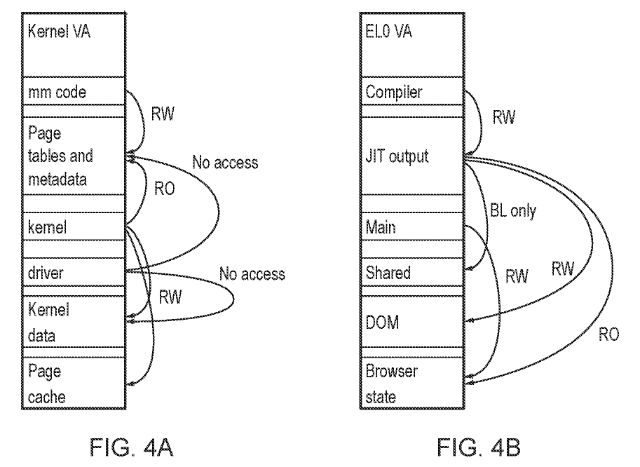

FIG. 4A illustrates an example of further memory access restrictions being imposed within a kernel VA space. In the example shown, memory management (mm) code is used to create / update page tables and associated metadata in a portion of this VA space and thus is permitted read / write access thereto. The kernel code itself is permitted read-only access to the page tables and associated metadata (such that its address translations can be carried out), but is afforded read / write access to portions of the VA space where kernel data and a page cache are stored. This is to be contrasted with a driver used by the kernel, which has no access to the page tables and associated metadata, and has no access to the kernel data. The operations of the memory management function are therefore protected with respect to the kernel and the driver(s), whilst the kernel operations are protected with respect to the driver(s). FIG. 4B illustrates an example of further memory access restrictions being imposed within a VA space used by a dynamic webpage application. A compiler is permitted read / write access to a portion of the address space in which the executable code it generates (the JIT output) is stored. However, that JIT output then has a range of permissions applied, depending on the target memory location. It has branch-only permission to access (and thus jump into) a region of shared code and has read / write access to a portion of the VA space where the document object model (DOM) data are stored. It is however limited to read only access to a portion of the VA space where the browser state is stored.

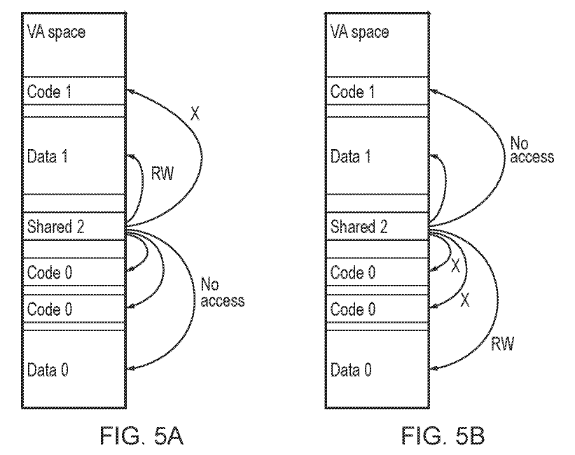

FIGS. 5A and 5B schematically illustrate the imposition of different permissions depending on the caller into a shared library. This is shown in these figures, in which FIG. 5A is an example of a first block of code (“Code 1”) calling a shared library (“Shared 2”), whilst FIG. 5B is an example of a second block of code (“Code 0”) calling the shared library. The purpose here is that, by setting up a different view of permissions according to the caller of the shared library, the library code is only able to manipulate the data of the caller (or even a subset of the data of the caller) and potentially its own private state. Conversely, the caller of the shared library cannot access data that is allocated for other callers of the shared library. Hence, the set up shown in FIG. 5A, in the situation when Code 1 calls the shared library Shared 2, allows Shared 2 read / write access to Code 1’s data (“Data 1”). Code 1 itself has execute access to the shared library Shared 2 (such that it can call this library) and the shared library Shared 2 has execute access to Code 1 (such that the program flow can return there following the library call). However, the shared library Shared 2 has no access to Code 0 or its associated data (“Data 0”). This is to be contrasted with the situation in FIG. 5B, which illustrates an example of a second block of code (“Code 0”) calling the shared library Shared 2”. Hence, the set up shown in FIG. 5B allows Shared 2 read / write access to Code 0’s data (“Data 0”). Code 0 itself has execute access to the shared library Shared 2 (such that it can call this library) and the shared library Shared 2 has execute access to Code 0 (such that the program flow can return there following the library call). However, the shared library Shared 2 has no access to Code 1 or its associated data Data 1.

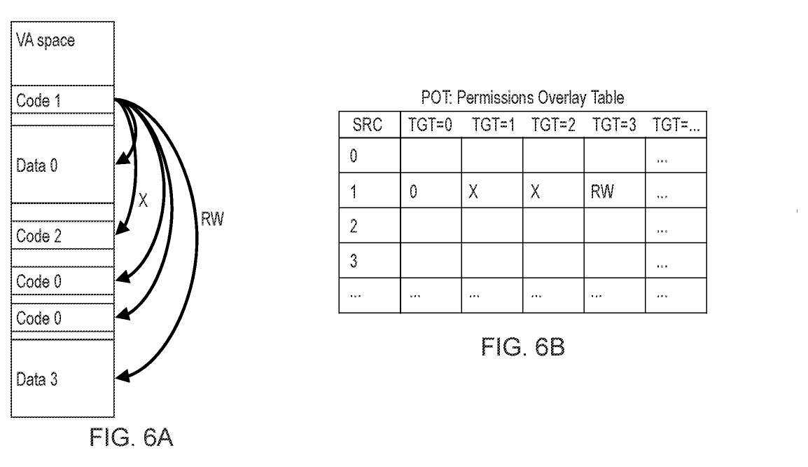

FIGS. 6A and 6B schematically illustrate the use of a permissions overlay table to control access restrictions dependent on the code seeking access and the target to which access is sought in accordance with some examples. These examples correspond to the control of access permissions when Code 1 is being executed. As an initial step in determining the applicable permissions, a base set of permissions, dependent only on the current / source region of code (“SRC”) are established. Here, SRC=1 and thus (accessing the permissions overlay table (“POT”) shown in FIG. 6B, yields the set of permissions {0, X, X, RW, …) (“Permissions”). The target region (“TGT”) (to which a given instruction within Code 1 is seeking access) is then used to select the finer-grained access permission for this combination, i.e. Permissions [TGT]. The example permissions shown for SRC=1 in FIG. 6B are thus: “X” (execute, i.e. branch / jump to) for target regions 1 and 2, and “RW” (read / write) for target region 3. The particular permissions allocated are dictated by the needs of particular instructions, e.g. LDR (load) needs R permission, STR (store) needs W permission, and B/RET (branch / return) needs X permission. FIG. 6A is a graphical equivalent, showing that region Code 1 has RW access to region Data 3 and X access to region Code 2, but has no access to the regions Data 0 or Code 0. Hence, it will be appreciated that the use of the permissions overlay table enables the provision of a distinct “view” of permissions for each region of code.

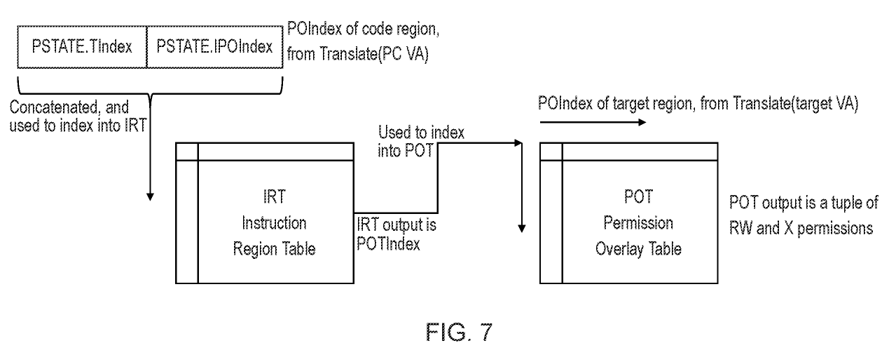

FIG. 7 schematically illustrates a two-stage permissions look-up process in accordance with some examples. In a first stage, information relating to the current process and the particular code being executed is used to determine a first level of the permissions to be allocated. To support this, memory pages are annotated (in their page table entries) with a permission overlay index (POIndex). Also, the processor state (here, PSTATE) held in the registers to define the current processing state is augmented by a temporal index field (TIndex). TIndex is controlled to correspond to the current execution context and, for example, is modified when the exception (privilege) level changes, such as on exception entry to a more privileged exception level or on legal exception return to a less privilegedexception level. Thus TIndex provides an element of the current context and as such is not a process identifier (e.g. an ASID), but rather a particular current execution context (of which there may therefore be several for a given process). On exception entry/return without a change in exception level, TIndex is unchanged. The permission overlay index forms part of the translation information accessed when a virtual address is translated into a physical address. At the first stage then, two identifiers PSTATE.TIndex and PSTATE.IPOIndex are derived. PSTATE.TIndex identifies what process is currently executing and PSTATE.IPOIndex (obtained by translating the program counter virtual address) identifies the particular code being executed. PSTATE.TIndex and PSTATE.IPOIndex are concatenated and used to index into an instruction region table (IRT). The IRT of this example is a one-dimensional table, with each entry comprising a permissions index (POTIndex). Note that there are distinct instruction region tables for each exception level. Next, in the second stage of the two-stage permissions look-up process, the POTIndex is used as a first index into a two-dimensional permission overlay table (POT). The second index then used to identify a particular entry in the POT is the POIndex of the target region of code or data, which is obtained by translating the target region virtual address. The identified POT entry thus forms the output of the two-stage permissions look-up process and in this example in the form of a tuple of R, W, and X permissions.

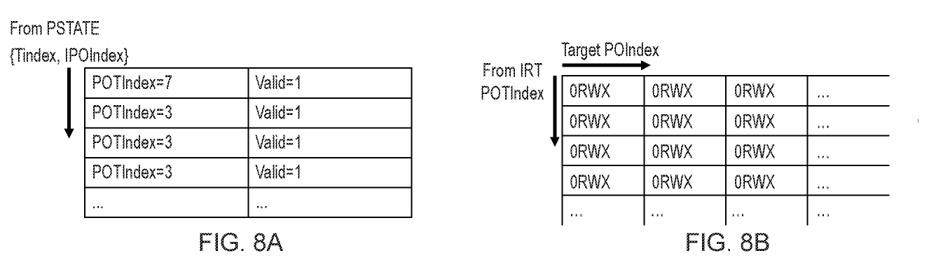

FIGS. 8A and 8B schematically illustrate the use of the above-mentioned instruction region table and permission overlay table to support a two-stage permissions look-up process in accordance with some examples. Being used in association with the address translation mechanisms, these are stored in the output address (OA) space (in a similar manner to translation tables). The one-dimensional instruction region table is indexed into by the PSTATE.TIndex + PSTATE.IPOIndex concatenation giving the POTIndex value. A valid bit also controls the validity of the entries. In one specific example embodiment, the table has 16-bit entries stored in 2¹⁴ rows thus occupying 32KB of storage space. The two-dimensional permissions overlay table is indexed into by the POTIndex output by the instruction region table and by the target code POIndex. In one specific example embodiment, the table has 128 rows and 128 columns of 4-bit entries, each giving the R, W, X overlay permissions, thus occupying 8KB of storage space. Further, in a variant of the embodiment shown in FIGS. 8A and 8B, an additional execution permission (“X bit”) can be added to the instruction region table (FIG. 8A) and the execute permission (“X”) is not provided as one of the overlay permissions given by the permission overlay table (FIG. 8B). In such as case, the instruction region table is still indexed by TIndex and POIndex from the translation of the PC VA. As such, the X bit in each IRT entry therefore indicates whether the specified TIndex is permitted to execute the specified POIndex. Thus a further execute permission (X bit) control is provided.

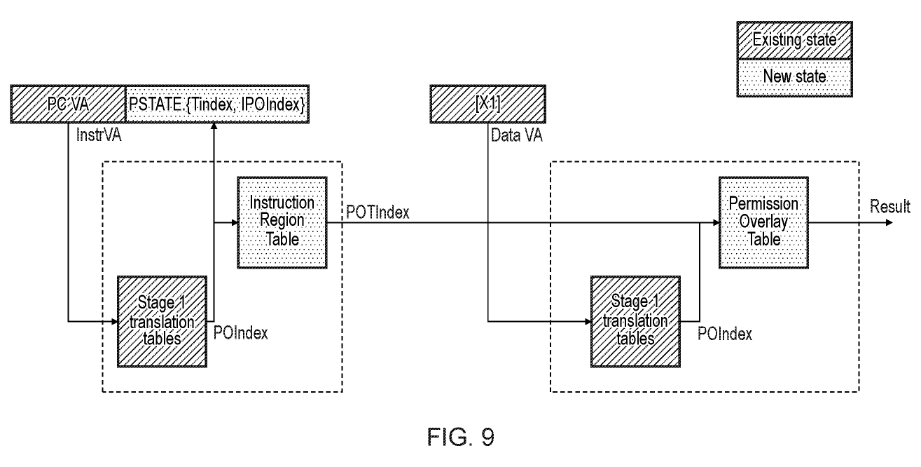

FIG. 9 schematically illustrates an example permission computation for a load instruction, e.g. LDR X0, [X1], in accordance with some examples. The VA of the source instruction (LDR) (i.e. the program counter (PC) VA) is fed into the stage 1 translation tables to give a POIndex. If the (partial) execution of the instruction does not generate an instruction abort, then the (source) POIndex from the translation of the PC VA is written into PSTATE.IPOIndex. This value is concatenated with PSTATE.TIndex (an element of the current execution context), and the concatenation of the two indexes into the instruction region table. The instruction region table output is a POTIndex. The load instruction’s target VA (i.e. the address from which the load sohoudl retrieve a data value) is fed into the stage 1 translation tables to give a (target) POIndex and this POIndex and the POTIndex are the indexes for the permissions overlay table, resulting in a set of overlay permissions. This output can be cached as (part of) a TLB entry as is described in more detail below.

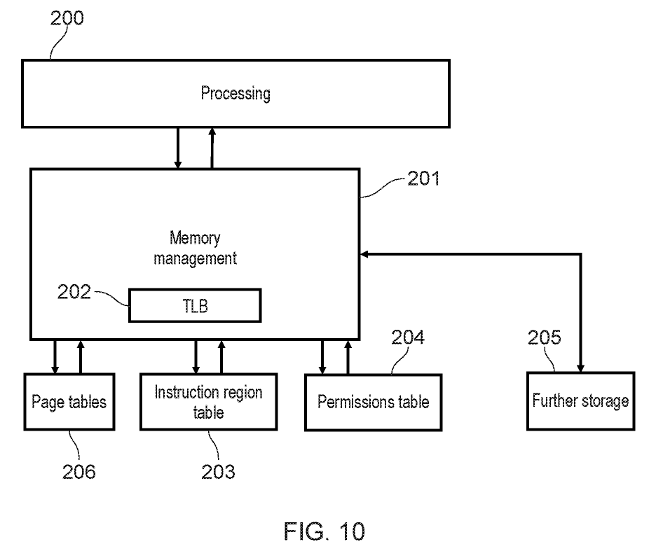

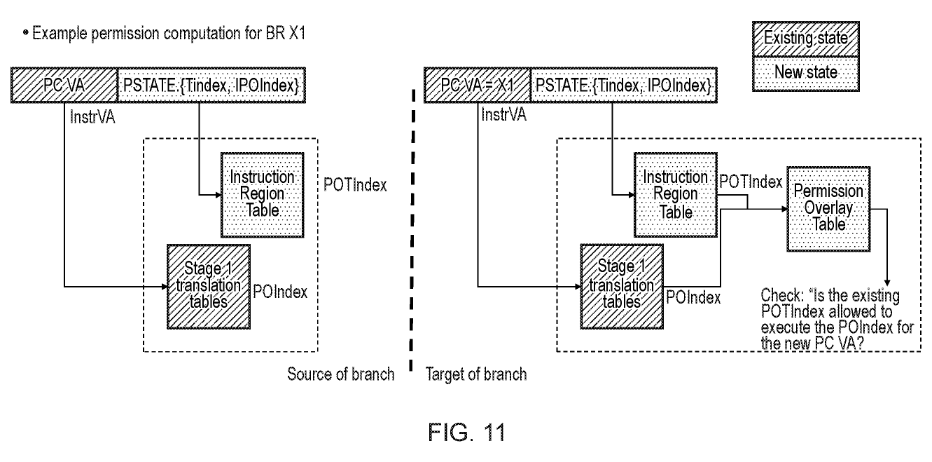

FIG. 10 schematically illustrates part of an apparatus comprising a memory management unit that controls access permissions in accordance with some examples. Access to memory initiated by instructions executed by the processing circuitry 200 are handled by the memory management unit (MMU) 201. The MMU 201 controls the process which translates virtual addresses (VA) used by the processing circuitry 200 into physical addresses used in the memory system being accessed. Page tables 206 stored in memory define the translations and further provide some access permissions associated with the regions of memory being accessed. Address translation information retrieved from the page tables is cached in the translation lookaside buffer (TLB) 202 in order to avoid the latency associated with a full page table walk (which is necessary the first time that a given translation is required) for repeatedly accessed memory locations. The MMU 201 also accesses an instruction region table 203 and a permissions table 204 in order to implement the present techniques, as described in more detail elsewhere herein. The output of the access to the permissions table, the permissions overlay information, is combined with the page table derived access permissions in order to derive the final access permissions that are imposed. This combination can be additive, i.e. that any action permitted by either the page table derived access permissions or the permissions overlay information is allowed. Alternatively, the combination can be subtractive, i.e. that for an action to be allowed it must be permitted by both the page table derived access permissions and the permissions overlay information. The latter approach is proposed in the example shown in FIG. 10. The outputs of the tables accessed and/or the final access permissions derived can also be cached. In one configuration of the arrangement shown in FIG. 10, entries in the TLB 202 are used to hold the permission overlay index (POIndex) value retrieved from the memory page tables. In this case, when an access needs to be checked, the MMU 201 has to re-fetch the permissions tables from memory, or may be provided with a separate storage structure 205 in which they are held. This further storage 205 can be provided as a caching structure (like a TLB), indexed by the appropriate POIndex values. In another configuration of the arrangement shown in FIG. 10, when the MMU 201 computes the final permissions according to the POIndex + permissions tables, these final permissions can then be combined with the corresponding TLB entry to and stored in the TLB 202.

FIG. 11 schematically illustrates an example permission computation for a branch instruction in accordance with some examples. The target address to which the branch should jump in this example is X1. Note that the left hand side of the figure schematically illustrates aspects of the permission computation relating to the source of the branch, whilst the right hand side of the figure schematically illustrates aspects of the permission computation relating to the target of the branch. The VA of the source of the branch (i.e. the current program counter (PC) VA) is fed into the stage 1 translation tables to give a POIndex. The branch instruction’s POIndex from the translation of the PC VA is written into PSTATE.IPOIndex. This value is concatenated with PSTATE.TIndex (an element of the current execution context), and the concatenation of the two indexes into the instruction region table. The instruction region table output is a POTIndex. The target of the branch, i.e. the target instruction VA, is fed into the stage 1 translation tables to give a (target) POIndex and this POIndex and the POTIndex are the indexes for the permissions overlay table, resulting in a set of overlay permissions. The combined final permissions are used to determine whether this branch is permitted, i.e. whether the current POTIndex (for the source of the branch) allowed to execute the POIndex for the new PC VA (i.e. the target instruction of the branch. If it is, the branch proceeds. If it is not, this is signalled to the processing circuitry.

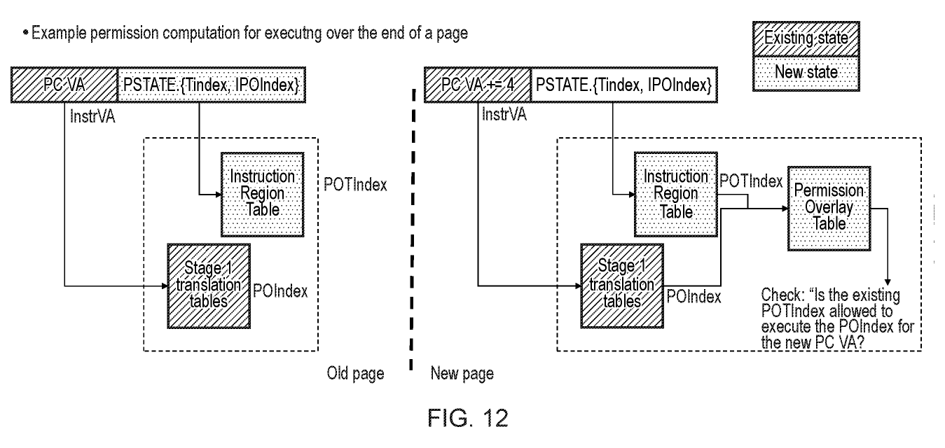

FIG. 12 schematically illustrates an example permission computation for code execution that crosses a page boundary in accordance with some examples. This is similar to the example of FIG. 11, except that the “source” here is the old page and the “target” is the new page. The left hand side of the figure schematically illustrates aspects of the permission computation relating to the old page, whilst the right hand side of the figure schematically illustrates aspects of the permission computation relating to the new page. The VA of the last instruction of the old page (i.e. the current program counter (PC) VA) is fed into the stage 1 translation tables to give a POIndex. The instruction’s POIndex from the translation of the PC VA is written into PSTATE.IPOIndex. This value is concatenated with PSTATE.TIndex (an element of the current execution context), and the concatenation of the two indexes into the instruction region table. The instruction region table output is a POTIndex. The first address of the new page, determined as PC VA + 4, is fed into the stage 1 translation tables to give a POIndex for the first address of the new page and this POIndex and the POTIndex are the indexes for the permissions overlay table, resulting in a set of overlay permissions. The combined final permissions are used to determine whether execution may indeed continue over the end of the old page onto the new page. When it is, sequential instruction execution continues. When it is not, this is signalled to the processing circuitry.

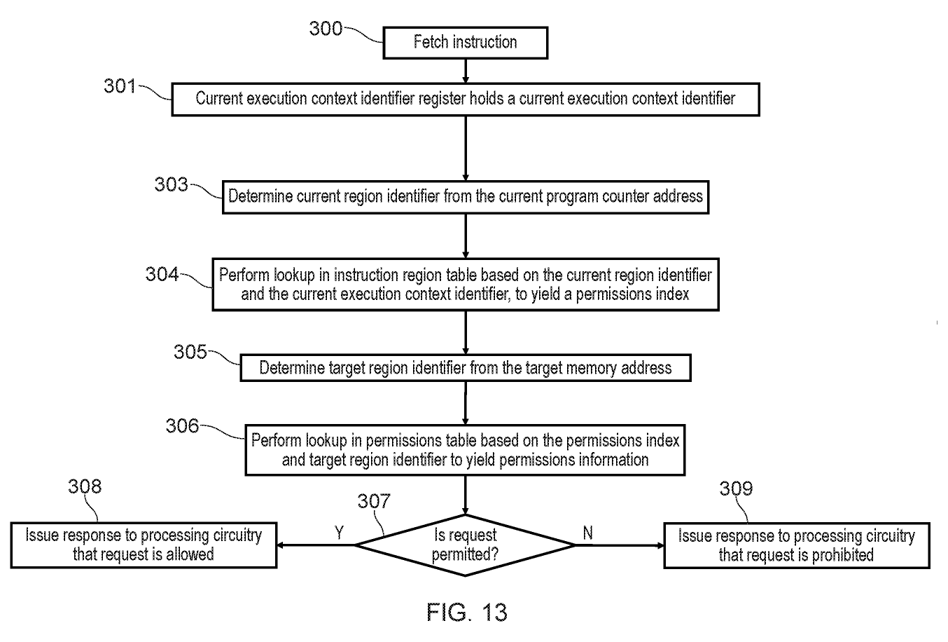

FIG. 13 is a flow diagram showing a sequence of steps which are taken in accordance with the method of some examples. The sequence shown begins at step 300 where an instruction is fetched and step 301 shows the current execution context identifier register holding a current execution context identifier. At step 303 a current region identifier is determined from the current program counter value. Then at step 304 a permissions index is determined based on the current region identifier and the current execution context identifier. In this example this is achieved by performing a look up in an instruction region table to yield the permissions index. Next at step 305 a target region identifier is determined from the target memory address. Then at step 306 a look up in a permissions table is performed based on the permissions index and the target region identifier to yield permissions information. It is then determined at step 307 whether the request is permitted to proceed. If it is not then the flow is proceeds to step 309 at which a response is issued (e.g. by the memory security circuitry) to the processing circuitry indicating that the request is prohibited. When the request is permitted the flow proceeds to step 308, issuing a response to the processing circuitry that the request is allowed. Note that an explicit “allowed” notification at step 308 may be omitted, and the re request is simply allowed to proceed.

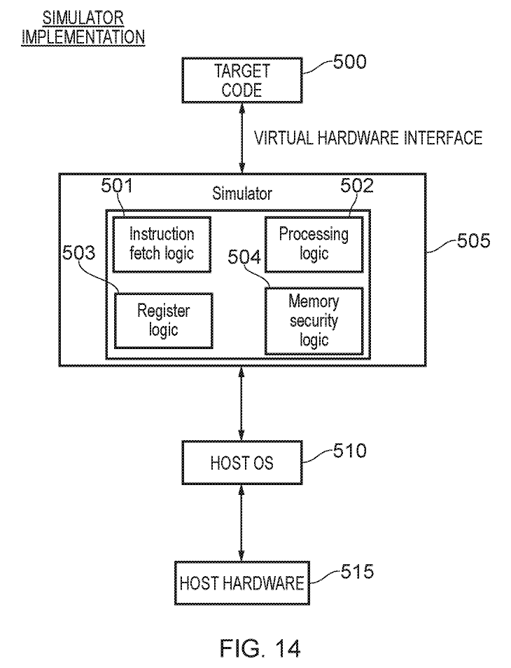

FIG. 14 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 515, optionally running a host operating system 510, supporting the simulator program 505. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53 - 63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 515), some simulated embodiments may make use of the host hardware, where suitable.

The simulator program 505 may be stored on a computer-readable storage medium (which may be a non-transitory medium), and provides a program interface (instruction execution environment) to the target code 500 (which may include applications, operating systems and a hypervisor) which is the same as the interface of the hardware architecture being modelled by the simulator program 505. Thus, the program instructions of the target code 500 may be executed from within the instruction execution environment using the simulator program 505, so that a host computer 515 which does not actually have the hardware features of the apparatuses discussed above can emulate these features, these being provided by instruction fetch logic 501, processing logic 502, register logic 503, and memory security logic 504.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various configurations within the scope of the present disclosure are set out in the following numbered clauses.

Clause 1. Apparatus comprising:

instruction fetch circuitry responsive to an instruction fetch address to fetch an instruction associated with the instruction fetch address;

processing circuitry responsive to the instruction to perform, when the instruction comprises a request specifying a target memory address, an operation dependent on the target memory address;

register circuitry to hold values indicative of a current processing state of the processing circuitry, wherein the register circuitry comprises a current execution context identifier register to hold a current execution context identifier indicative of a current execution context within a current process which has caused the instruction to be fetched; and

memory security circuitry to, when the instruction comprises the request specifying the target memory address:

determine, based on the instruction fetch address, a current region identifier;

determine, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

Clause 2. The apparatus of Clause 1, wherein the memory security circuitry comprises table access circuitry to perform a look-up in an instruction region table in memory based on the current region identifier and the current execution context identifier to determine the permissions index.

Clause 3. The apparatus of Clause 2, wherein the instruction region table is a one-dimensional table and the memory security circuitry is configured to concatenate the current region identifier and the current execution context identifier to provide an index for the look-up in the instruction region table.

Clause 4. The apparatus of any of Clauses 1-3, wherein the memory security circuitry comprises table access circuitry to perform a look-up in the permissions table in memory based on the permissions index and the target region identifier to determine the permissions information.

Clause 5. The apparatus of Clause 4, wherein the permissions table is a two-dimensional table and the memory security circuitry is configured to use the permissions index as a first index and the target region identifier as a second index for the look-up in the permissions table.

Clause 6. The apparatus of any of Clauses 1-5, wherein the memory security circuitry is configured to:

determine, based on page table access permissions information derived from a page table entry associated with the target memory address, whether the request is prohibited; and

issue, in response to determining that request is prohibited based on at least one of the permissions information and the page table access permissions information, the response indicating that the request is prohibited.

Clause 7. The apparatus of Clause 6, wherein the memory security circuitry is configured to determine the current region identifier by accessing a page table entry associated with the instruction fetch address and to determine the target region identifier by accessing a page table entry associated with the target memory address,

wherein page table entries comprise the page table access permissions information and a region identifier,

wherein the region identifier is the current region identifier in the page table entry associated with the instruction fetch address and the region identifier is the target region identifier in the page table entry associated with the target memory address.

Clause 8. The apparatus of Clause 7, wherein the memory security circuitry is configured to perform address translations with reference to address translation information derived from page table entries in memory,

wherein the memory security circuitry comprises address translation storage to store local copies of recently-used address translation information,

and wherein the memory security circuitry is configured to store associated region identifiers with the local copies of recently-used address translation information in the address translation storage.

Clause 9. The apparatus of Clause 8, wherein the memory security circuitry is configured to store local copies of recently-used target region identifiers in the address translation storage, and wherein the memory security circuitry is responsive to a cache hit on a local copy of a recently-used target region identifier to retrieve corresponding permissions information from a further storage.

Clause 10. The apparatus of Clause 8, wherein the memory security circuitry is configured generate a combined entry in dependence on the target region identifier and the permissions information for storage in the address translation storage.

Clause 11. The apparatus of any of Clauses 6-10, wherein the memory security circuitry is configured to modify the page table access permissions information by the permissions information when determining whether the request is prohibited.

Clause 12. The apparatus of Clause 11, wherein the memory security circuitry is configured to remove permissions from the page table access permissions information based on the permissions information when determining whether the request is prohibited.

Clause 13. The apparatus of any preceding Clause, wherein the permissions index is retrieved from an instruction region table in memory based on the current region identifier and the current execution context identifier and wherein the permissions information is retrieved from a permissions table in memory based on the permissions index and the target region identifier.

Clause 14. The apparatus of Clause 13, wherein the register circuitry comprises at least one table base address register to store base addresses for the instruction region table and the permissions table.

Clause 15. The apparatus of Clause 13 or Clause 14, wherein the processing circuitry is configured to operate in a current mode of a less privileged mode and a more privileged mode,

wherein when in the less privileged mode the permissions index is retrieved from an first instruction region table and when in the more privileged mode the permissions index is retrieved from a second instruction region table,

and wherein when in the less privileged mode the permissions information is retrieved from a first permissions table and when in the more privileged mode the permissions information is retrieved from a second permissions table.

Clause 16. The apparatus of Clause 1, wherein the current region identifier is the same as the target region identifier.

Clause 17. A method comprising:

fetching, in response to an instruction fetch address, an instruction associated with the instruction fetch address;

holding values in registers indicative of a current processing state, wherein the registers comprises a current execution context identifier register to hold a current execution context identifier indicative of a current execution context within a current process which has caused the instruction to be fetched;

when the instruction comprises a request specifying a target memory address:

performing, in response to the instruction, an operation dependent on the target memory address; and

when the instruction comprises the request specifying the target memory address:

determining, based on the instruction fetch address, a current region identifier;

determining, based on the current region identifier and the current execution context identifier, a permissions index;

determining, based on the target memory address, a target region identifier;

performing a lookup in a permissions table, based on the permissions index and the target region identifier, to yield permissions information for requests issued in response to instructions associated with the current execution context identifier and the current region identifier that specify the target memory address;

determining, based on the permissions information, whether the request is prohibited; and

issuing, in response to determining that the request is prohibited, a response to the processing circuitry indicating that the request is prohibited.

Clause 18. A computer program for controlling a host data processing apparatus to provide an instruction execution environment, the computer program comprising:

instruction fetch program logic responsive to an instruction fetch address to fetch an instruction associated with the instruction fetch address;

processing program logic responsive to the instruction to perform, when the instruction comprises a request specifying a target memory address, an operation dependent on the target memory address;

register program logic to hold values indicative of a current processing state of the processing program logic, wherein the register program logic comprises a current execution context identifier register program logic to hold a current execution context identifier indicative of a current execution context within a current process which has caused the instruction to be fetched; and

memory security program logic to, when the instruction comprises the request specifying the target memory address:

determine, based on the instruction fetch address, a current region identifier;

determine, based on the current region identifier and the current execution context identifier, a permissions index;

determine, based on the target memory address, a target region identifier;

perform a lookup in a permissions table, based on the permissions index and the target region identifier, to yield permissions information for requests issued in response to instructions associated with the current execution context identifier and the current region identifier that specify the target memory address;

determine, based on the permissions information, whether the request is prohibited; and

issue, in response to determining that the request is prohibited, a response to the processing circuitry indicating that the request is prohibited.

Clause 19. A computer-readable storage medium to store the computer program of Clause 18.

In brief overall summary, apparatuses, methods, computer programs, and computer-readable storage media are disclosed, wherein an instruction associated with instruction fetch address is fetched and processing performs, when the instruction comprises a request specifying a target memory address, an operation dependent on the target memory address. Registers hold values indicative of a current processing state and a current execution context identifier register holds a current execution context identifier indicative of a current execution context within a current process that caused the instruction to be fetched. Memory security, when the instruction comprises the request specifying the target memory address, determines, based on the instruction fetch address, a current region identifier; determines, based on the current region identifier and the current execution context identifier, a permissions index. A target region identifier is determined based on the target memory address and a lookup in a permissions table, based on the permissions index and the target region identifier, yields permissions information for requests issued in response to instructions associated with the current execution context identifier and the current region identifier that specify the target memory address. Based on the permissions information it is determined whether the request is prohibited.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
instruction fetch circuitry responsive to an instruction fetch address to fetch an instruction associated with the instruction fetch address;
processing circuitry responsive to the instruction to perform, when the instruction comprises a request specifying a target memory address, an operation dependent on the target memory address;
register circuitry to hold values indicative of a current processing state of the processing circuitry, wherein the register circuitry comprises a current execution context identifier register to hold a current execution context identifier indicative of a current execution context within a current process which has caused the instruction to be fetched; and
memory security circuitry to, when the instruction comprises the request specifying the target memory address:
determine, based on the instruction fetch address, a current region identifier;
determine, based on the current region identifier and the current execution context identifier, a permissions index;
determine, based on the target memory address, a target region identifier;
perform a lookup in a permissions table, based on the permissions index and the target region identifier, to yield permissions information for requests issued in response to instructions associated with the current execution context identifier and the current region identifier that specify the target memory address;
determine, based on the permissions information, whether the request is prohibited; and
issue, in response to determining that the request is prohibited, a response to the processing circuitry indicating that the request is prohibited.

2. The apparatus of claim 1, wherein the memory security circuitry comprises table access circuitry to perform a look-up in an instruction region table in memory based on the current region identifier and the current execution context identifier to determine the permissions index.

3. The apparatus of claim 2, wherein the instruction region table is a one-dimensional table and the memory security circuitry is configured to concatenate the current region identifier and the current execution context identifier to provide an index for the look-up in the instruction region table.

4. The apparatus of claim 1, wherein the memory security circuitry comprises table access circuitry to perform a look-up in the permissions table in memory based on the permissions index and the target region identifier to determine the permissions information.

5. The apparatus of claim 4, wherein the permissions table is a two-dimensional table and the memory security circuitry is configured to use the permissions index as a first index and the target region identifier as a second index for the look-up in the permissions table.

6. The apparatus of claim 1, wherein the memory security circuitry is configured to:
determine, based on page table access permissions information derived from a page table entry associated with the target memory address, whether the request is prohibited; and
issue, in response to determining that request is prohibited based on at least one of the permissions information and the page table access permissions information, the response indicating that the request is prohibited.

7. The apparatus of claim 6, wherein the memory security circuitry is configured to determine the current region identifier by accessing a page table entry associated with the instruction fetch address and to determine the target region identifier by accessing a page table entry associated with the target memory address,
wherein page table entries comprise the page table access permissions information and a region identifier,
wherein the region identifier is the current region identifier in the page table entry associated with the instruction fetch address and the region identifier is the target region identifier in the page table entry associated with the target memory address.

8. The apparatus of claim 7, wherein the memory security circuitry is configured to perform address translations with reference to address translation information derived from page table entries in memory,
wherein the memory security circuitry comprises address translation storage to store local copies of recently-used address translation information,
and wherein the memory security circuitry is configured to store associated region identifiers with the local copies of recently-used address translation information in the address translation storage.

9. The apparatus of claim 8, wherein the memory security circuitry is configured to store local copies of recently-used target region identifiers in the address translation storage, and wherein the memory security circuitry is responsive to a cache hit on a local copy of a recently-used target region identifier to retrieve corresponding permissions information from a further storage.

10. The apparatus of claim 8, wherein the memory security circuitry is configured generate a combined entry in dependence on the target region identifier and the permissions information for storage in the address translation storage.

11. The apparatus of claim 6, wherein the memory security circuitry is configured to modify the page table access permissions information by the permissions information when determining whether the request is prohibited.

12. The apparatus of claim 11, wherein the memory security circuitry is configured to remove permissions from the page table access permissions information based on the permissions information when determining whether the request is prohibited.

13. The apparatus of claim 1, wherein the permissions index is retrieved from an instruction region table in memory based on the current region identifier and the current execution context identifier and wherein the permissions information is retrieved from a permissions table in memory based on the permissions index and the target region identifier.

14. The apparatus of claim 13, wherein the register circuitry comprises at least one table base address register to store base addresses for the instruction region table and the permissions table.

15. The apparatus of claim 13, wherein the processing circuitry is configured to operate in a current mode of a less privileged mode and a more privileged mode,
wherein when in the less privileged mode the permissions index is retrieved from an first instruction region table and when in the more privileged mode the permissions index is retrieved from a second instruction region table,
and wherein when in the less privileged mode the permissions information is retrieved from a first permissions table and when in the more privileged mode the permissions information is retrieved from a second permissions table.

16. The apparatus of claim 1, wherein the current region identifier is the same as the target region identifier.

17. A method comprising:
fetching, in response to an instruction fetch address, an instruction associated with the instruction fetch address;
holding values in registers indicative of a current processing state, wherein the registers comprises a current execution context identifier register to hold a current execution context identifier indicative of a current execution context within a current process which has caused the instruction to be fetched;
when the instruction comprises a request specifying a target memory address:
performing, in response to the instruction, an operation dependent on the target memory address; and
when the instruction comprises the request specifying the target memory address:
determining, based on the instruction fetch address, a current region identifier;
determining, based on the current region identifier and the current execution context identifier, a permissions index;
determining, based on the target memory address, a target region identifier;
performing a lookup in a permissions table, based on the permissions index and the target region identifier, to yield permissions information for requests issued in response to instructions associated with the current execution context identifier and the current region identifier that specify the target memory address;
determining, based on the permissions information, whether the request is prohibited; and
issuing, in response to determining that the request is prohibited, a response to the processing circuitry indicating that the request is prohibited.

18. A computer program for controlling a host data processing apparatus to provide an instruction execution environment, the computer program comprising:
instruction fetch program logic responsive to an instruction fetch address to fetch an instruction associated with the instruction fetch address;
processing program logic responsive to the instruction to perform, when the instruction comprises a request specifying a target memory address, an operation dependent on the target memory address;
register program logic to hold values indicative of a current processing state of the processing program logic, wherein the register program logic comprises a current execution context identifier register program logic to hold a current execution context identifier indicative of a current execution context within a current process which has caused the instruction to be fetched; and
memory security program logic to, when the instruction comprises the request specifying the target memory address:
determine, based on the instruction fetch address, a current region identifier;
determining, based on the current region identifier and the current execution context identifier, a permissions index;
determine, based on the target memory address, a target region identifier;
perform a lookup in a permissions table, based on the permissions index and the target region identifier, to yield permissions information for requests issued in response to instructions associated with the current execution context identifier and the current region identifier that specify the target memory address;
determine, based on the permissions information, whether the request is prohibited; and
issue, in response to determining that the request is prohibited, a response to the processing circuitry indicating that the request is prohibited.

19. A computer-readable storage medium to store the computer program of claim 18.
